(19) United States
(12) Patent Application Publication
(10) Pub. No.: US 2011/0128849 A1
(43) Pub. Date: Jun. 2, 2011

(54) Signaling for Safety Message Transmission in Vehicular Communication Networks

(76) Inventor: Jianlin Guo, Malden, MA (US)

(21) Appl. No.: 12/629,607

(22) Filed: Dec. 2, 2009

(51) Int. Cl. H04W 28/10

(52) U.S. Cl. 370/235

(57) ABSTRACT

Messages are broadcast in a vehicular environment using a network of nodes. Each node includes a transceiver and a processor arranged in a vehicle. A bandwidth of the network is partitioned into a set of channels including a control channel (CCH) and multiple service channel (SCH). Time is partitioned into alternating control channel intervals (CCHI) and service channel intervals (SCHI). A particular node transmits an attention signal indicating intent to access a particular channel to transmit a high priority safety message, wherein the network is designed according to a standard for a vehicular environment. The node then waits a random length backoff time and transmits the high priority safety message related to the vehicular environment after the random length backoff time.

### RELATED APPLICATION

This application is related to U.S. patent application Ser. No. 12/______ entitled “Broadcasting Messages in Multi-Channel Vehicular Networks” filed by Jianlin Guo on Dec. 2, 2009, incorporated herein by reference.

### FIELD OF THE INVENTION

This invention relates generally to wireless communications, and more particularly to congestion control in vehicular communication networks.

### BACKGROUND OF THE INVENTION

### Vehicular Ad-Hoc Networks

Governments and manufacturers are cooperating to improve traffic and vehicle safety using vehicular ad-hoc networks (VANETs), e.g., as specified by the IEEE 802.11p and IEEE P1609 standards. Other standards, such as communications access for land mobiles (CALM) can also be used. Vehicles in VANETS broadcast traffic and vehicle information, such as a location, velocity, acceleration, and braking status in periodic heartbeat messages, typically every 100 milliseconds. Each vehicle participating in the network include a transceiver, and messages are transmitted by the nodes as packets. Hence, vehicles and nodes, and messages and packets are used interchangeably herein.

As shown in FIG. 1, the Federal Communications Commission (FCC) has allocated a 75 MHz bandwidth 101 at 5.9 GHz for intelligent traffic system (ITS) applications such as VANETS. The bandwidth is allocated exclusively for vehicle-to-vehicle (V2V) communications and vehicle-to-infrastructure (V2I) communications between the nodes. Dedicated short range (≈0.3 to 1 km) communications (DSRC) has been adopted as a technique for ITS services on this bandwidth.

The bandwidth is partitioned into multiple channels, e.g., seven 10 MHz channels including a control channel (CCH) 110 and six service channels (SCH) 120. The CCH CH178 is only used for public safety and control purposes. No private services are allowed on the CCH. The six SCH service channels are CH172, CH174, CH176, CH180, CH182, and CH184. Channels CH174, CH176, CH180, and CH182 are used for public safety and private services. Channels CH172 and CH184 are allocated as dedicated public safety channels, V2V public safety channel and intersection public safety channel, respectively. It should be noted that other channel partitioning schemes can be used.

Transmit powers limits are defined for the channels. CH178 has two transmission power limits, 33 dBm for non-emergency vehicles, and 44.8 dBm for emergency vehicles. For the middle range service channel CH174 and CH176, the transmission power limit is 33 dBm. For the short range service channel CH180 and CH182, the transmission power limit is 23 dBm. For dedicated public safety channels CH172 and CH184, the transmission power limits are 33 dBm and 40 dBm, respectively.

DSRC is standardized in a Wireless Access in Vehicular Environments (WAVE) protocol according to the IEEE 802.11p and IEEE P1609 standards. For channel coordination and channel synchronization, WAVE partitions time into 100 millisecond Sync Intervals. Each Sync Interval is further partitioned into a 50 milliseconds control channel interval (CCHI), and a 50 milliseconds service channel interval (SCHI). A 4 millisecond Guard Interval (GI) at the beginning of each channel interval accommodates variations in timing. During the CCHI, high priority messages are broadcasted on the CCH while each transceiver monitors the CCH. The messages can be broadcasted on any channel during the SCHI. WAVE imposes a maximum 54 millisecond latency.

The FCC has established three priority levels for ITS messages: safety of life, public safety, and non-priority. The lower priority messages can tolerate transmission latency, while high priority messages cannot. Based on the three priority levels, the SAE J2735 standard defines formats for a la carte message, a basic safety message, a common safety request message, an emergency vehicle alert message, and a generic transfer message.

The basic safety message contains safety-related information that is periodically broadcast. The common safety request message allows for specific vehicle safety-related information requests to be made that are required by vehicle safety applications. The emergency vehicle alert message is used for broadcasting warnings that an emergency vehicle is operating in the vicinity. The probe vehicle data message contains status information about the vehicle for different periods of time that is broadcasted to roadside equipment. The a la carte and generic transfer messages allow for flexible structural or bulk message exchange.

Of particular concern to the invention are high priority messages, such as crash-pending notification, hard brake, and control loss, which can only have a latency of up to 10 milliseconds. Other warning messages can have a latency up to 20 milliseconds, e.g., emergency vehicle approaching. The messages, such as probe and general traffic information, can have a latency of more than 20 milliseconds.

Channel Congestion

In wireless communication networks, a major cause of packet drop and long latency is channel congestion. Channel congestion is an issue to be addressed in ITS standards, namely IEEE Wireless Access in Vehicular Environments (WAVE) and ISO communications access for land mobiles (CALM). The reason is that both WAVE and CALM use Enhanced Distributed Channel Access (EDCA) as medium access protocol. EDCA is defined in the IEEE 802.11 standard. It is a contention based channel access protocol using a CSMA/CA mechanism for medium access. EDCA can experience unpredictable channel access delay and packet drops due to its undeterministic characteristics. When a higher priority packet contends for channel access at the same time as a lower priority packet, EDCA does not guarantee that the higher priority packet gain access first. The higher priority packet only has a higher probability of gaining access.

A WAVE channel gets congested when more than fifty nodes operate on the channel. It has been shown that on a six lane high way, if a destination node is 150 meters from a source node, the latency is greater than 50 milliseconds after WAVE channel usage reaches 50%. Therefore, a congestion control mechanisms must be provided in order to achieve SAE's latency requirement for high priority safety messages in vehicular communication networks.

### SUMMARY OF THE INVENTION

The embodiments of the invention provide a method for reducing latency and increasing reliability of high priority safety messages in vehicular ad-hoc networks (VANETs). A node with a high priority safety message transmits an attention signal to indicate intent to gain channel access and transmit the high priority safety message. In response, other nodes that receive the attention signal defer transmissions. The invention also provides an adaptive control channel interval scheme for WAVE networks to reduce latency for high priority safety messages.

Messages are broadcasted in a vehicular environment using a network of nodes. Each node includes a transceiver and a processor arranged in a vehicle. A bandwidth of the network is partitioned into a set of channels including a control channel (CCH) and multiple other channels such as service channel (SCH).

Time is partitioned into alternating control channel intervals (CCHI) and service channel intervals (SCHI). A particular node transmits an attention signal indicating intent to access a particular channel to transmit a high priority safety message, wherein the network is designed according to a standard for a vehicular environment.

The node then waits a random length backoff time and transmits the high priority safety message after the random length backoff time.

### BRIEF DESCRIPTION OF THE DRAWINGS

FIG. 1 is a block diagram of standardized WAVE channel allocation used by embodiments of the invention;

FIG. 2 is a schematic of EDCA channel access mechanism used by embodiments of the invention;

FIG. 3 is a schematic of signal slot selection according to embodiments of the invention;

FIG. 4A is a schematic of a signaling technique for transmitting a high priority safety message according to embodiments of the invention;

FIG. 4B is a schematic of a signaling technique for avoiding collisions between low and high priority messages according to embodiments of the invention;

FIG. 5A is a flow diagram of a procedure used by a safety message node to transmit signal and safety messages according to embodiments of the invention;

FIG. 5B is a flow diagram of a procedure used by a non-safety message node to detect signal and defer channel access according to embodiments of the invention;

FIG. 6 is a schematic of WAVE Sync interval structure used by embodiments of the invention;

FIG. 7 a schematic of a structure of an adaptive control channel interval according to embodiments of the invention; and

FIG. 8 is a schematic of a WAVE Sync interval with one adaptive control channel interval placed in SCH interval according to embodiments of the invention.

### DETAILED DESCRIPTION OF THE PREFERRED EMBODIMENTS

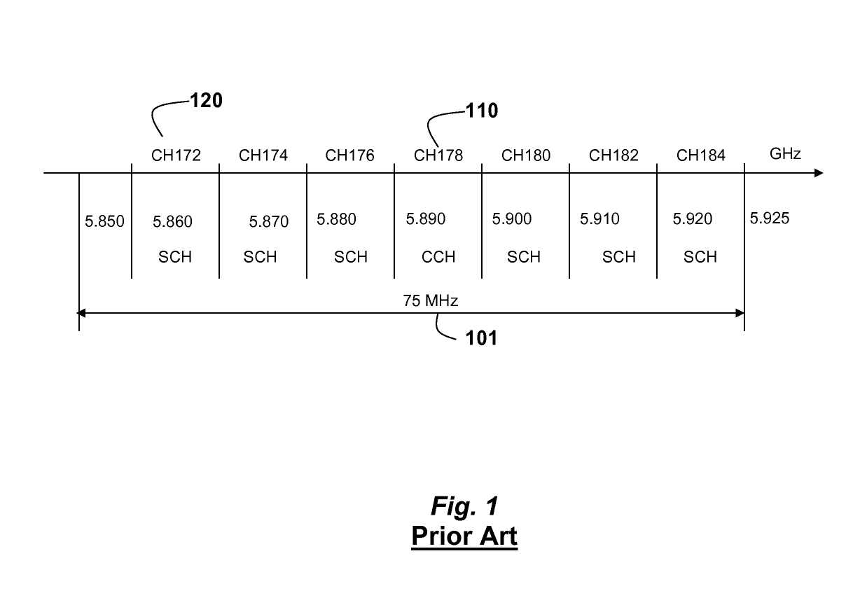

Radio frequency spectrum has been dedicated for intelligent traffic system (ITS). The U.S. allocates 75 MHz in 5.9 GHz bands, Europe allocates 30 MHz in 5.9 GHz bands and 20 MHz in 5.8 GHz bands, and Japan allocates 80 MHz in 5.8 GHz bands. The allocated bands are used for vehicle-to-vehicle (V2V), vehicle-to-roadside (V2R) and roadside-to-roadside (R2R) ITS applications. Two ITS standards are under development, for the U.S. IEEE WAVE, and for Europe CALM. Both WAVE and CALM support multi-channel operations. WAVE supports two types of channels: control channel (CCH) and service channel (SCH). CALM supports three types of channels: CCH, SCH and auxiliary channel (ACH). For WAVE, seven 10 MHz channels are planed with one CCH and six SCHs as shown in FIG. 1.

CCH is used for high priority messages, control messages and management messages in both WAVE and CALM. Periodic “heartbeat” messages are transmitted on the CCH every 100 milliseconds. Service announcement messages, and public safety information messages, such as geospatial context and emergency vehicle approaching, are also transmitted on the CCH. All these messages can cause congestion and delay on the CCH. To achieve a latency of less than 10 milliseconds, additional congestion control mechanisms are needed. The embodiments of the invention provide a signaling technique for congestion control, and an adaptive control channel interval scheme to reduce the latency of high priority safety messages.

Signaling for Safety Message Transmission in Vehicular Communication Networks

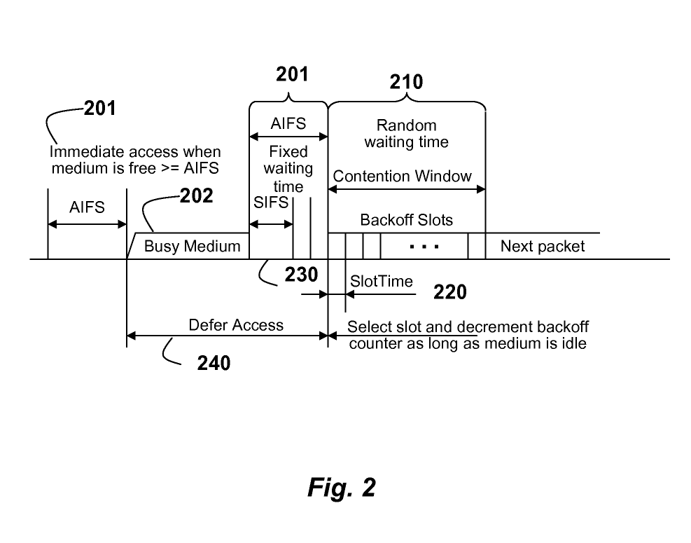

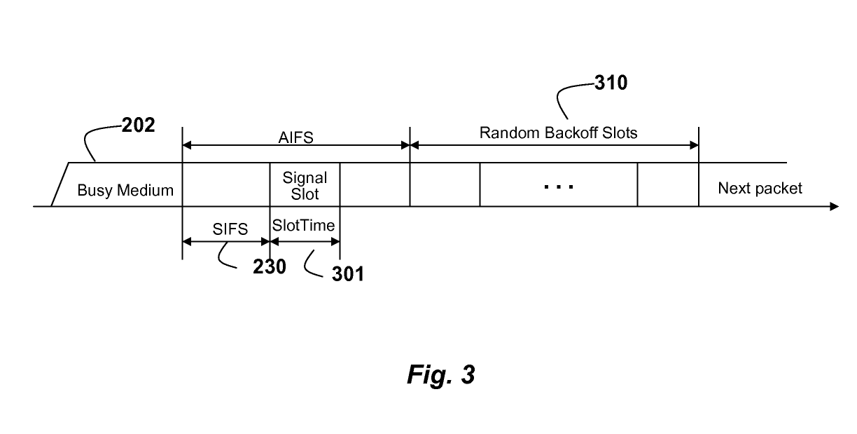

FIGS. 2-3 show the EDCA channel access mechanism according to embodiments of the invention. EDCA supports four access categories (AC): AC_BK for background, AC_BE for best effort, AC_VI for video and AC_VO for voice. Each packet of a message is mapped to one access category (AC) according to a priority level. WAVE has 8 levels, and CALM has 256.

A set of EDCA parameter is defined for each AC to contend for the channel access. A backoff time for EDCA includes a fixed length waiting time and a random length waiting time. The fixed waiting time is a number of time slots given by arbitration interframe space (AIFS) 201. The random waiting time is a random number of time slots 310 in a contention window (CW) 210. Both AIFS and CW are different for each AC. AIFS is defined using two basic EDCA time parameters: short interframe space time (SIFSTime) 230, and a slot time (SlotTime) 220:

AIFS=AIFSN×SlotTime+SIFSTime. (1).

The Arbitration Interframe Space Number (AIFSN) is AC dependent can have value in the range from 2 to 9. CW is an integer within a range of values CWmin and CWmax, such that CWmin≦CW≦CWmax. Both CWmin and CWmax are AC dependent.

A node can immediately transmit packet if the medium is free for more than one AIFS time period 201. However, following busy medium, all nodes have to perform a random backoff procedure for packet transmission. This indicates that random backoff is needed on congested channels. Random backoff can cause unpredictable delay and packet drop even for high priority messages. To guarantee safety message transmission on a congested channel, the invention provides an efficient congestion control technique: signaling for safety message transmission.

As shown in FIG. 3, the signal slot 301 after SIFS time period 230 is selected as the time slot to transmit an attention signal. Following busy medium 202, nodes with safety message to transmit send the attention signal in the signal slot 301. The attention signal indicates intent by the node to send a high priority safety message.

Nodes with safety messages perform regular random backoff procedure and transmit the safety message as if the attention signal was not transmitted. Nodes with other messages to transmit also perform a regular backoff procedure.

However, nodes with non-safety message attempt to detect the attention signal during the signal slot 301. If the attention signal is detected during the signal slot, nodes with non-safety message defer access 240 to the medium so that safety message can be transmitted first.

Equation (1) shows that the shortest backoff time is longer than SIFSTime. This means that no initiation of the frame exchange sequence starts at SIFSTime following the busy medium. In the IEEE 802.11 standard, SIFS is only used prior to transmission of ACK, CTS, subsequent fragment of a fragment burst and poll response. EDCA does not support polling mechanism and therefore, there is no poll response. No burst transmission is allowed by CALM. For WAVE, burst transmission is prohibited on CCH. The default EDCA parameter set indicates no burst transmission on the SCHs. ACK and CTS are unicast packets. In fact, request-to-send and clear-to-send (RTS/CTS) are not recommended in current version of CALM.

Even though the probability of using the signal slot 301, as specified by the standard, is very small, to avoid a violation of the standard, the attention signal is not transmitted in following cases: when an immediate previous packet requires an ACK, or when the immediate previous packet is RTS, or when the immediate previous packet indicates a need to transmit a subsequent packet.

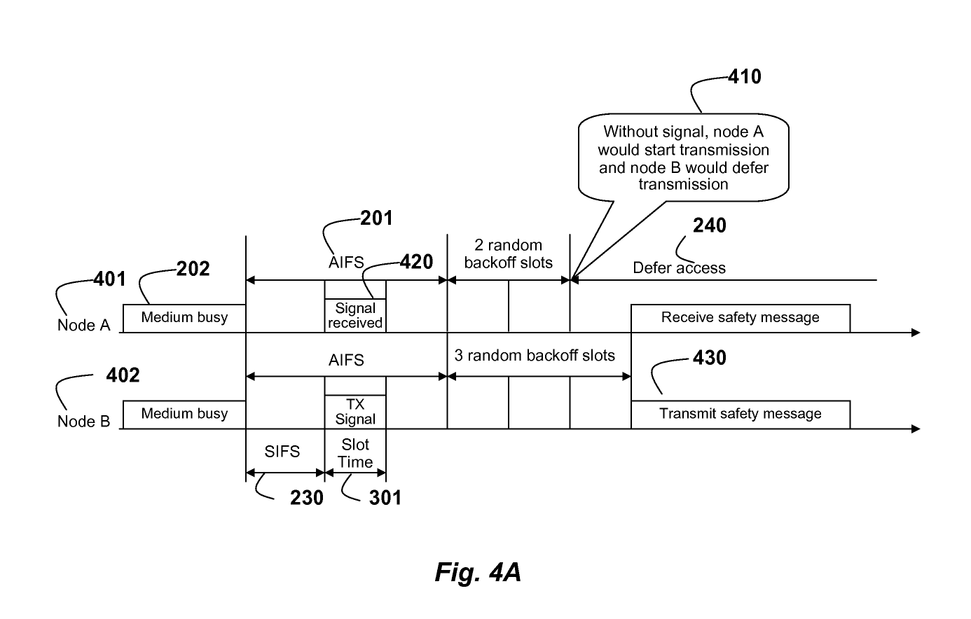

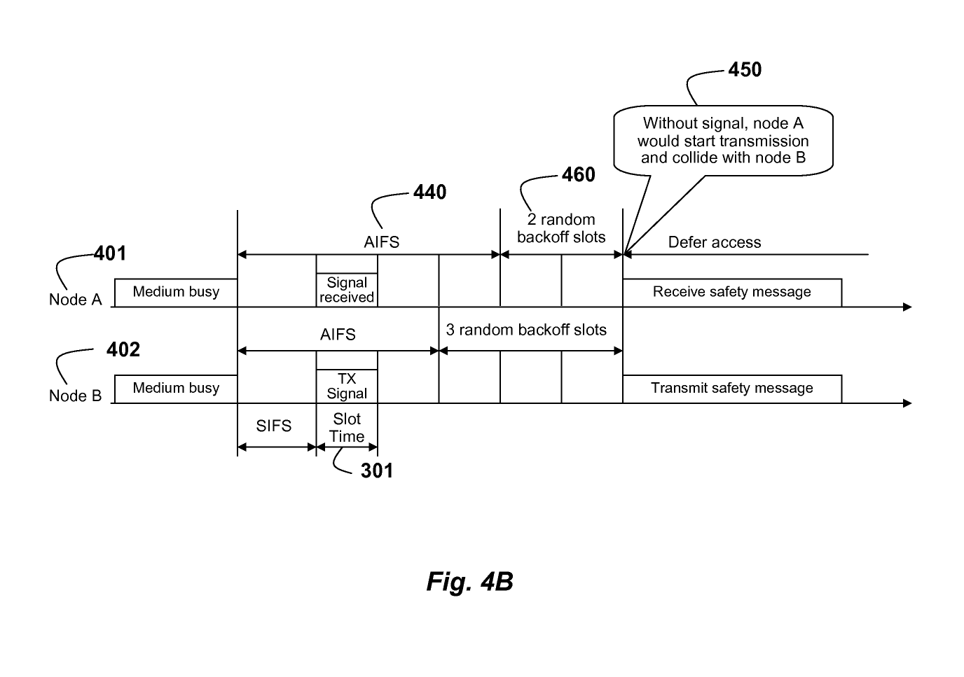

FIG. 4A shows an example of the signaling technique according to the embodiments of the invention. Nodes A and B contend for transmission on the channel. Node A 401 is non-safety message node, and node B 402 is safety message node. Node A and node B have equal AIFS 201. However, node A has a shorter random length backoff time. Without the attention signal by node B, node A would transmits first 410. Because node A receives the attention signal 420 from node B, node A defers channel access. Therefore, node B transmits 430 the high priority safety message first.

FIG. 4B shows that the signaling technique avoids lower priority message colliding with high priority safety message, where node A is non-safety message node with a lower priority message and node B is safety message node. Node A has a longer AIFS 440. However, node A has a shorter random length backoff time 460. Without the attention signal by node B, node A and node B would collide 450 because the nodes have same total waiting time. Because node A receives the attention signal from node B, node A defers channel access. Therefore, the signaling technique avoids a safety message collision and improves reliability.

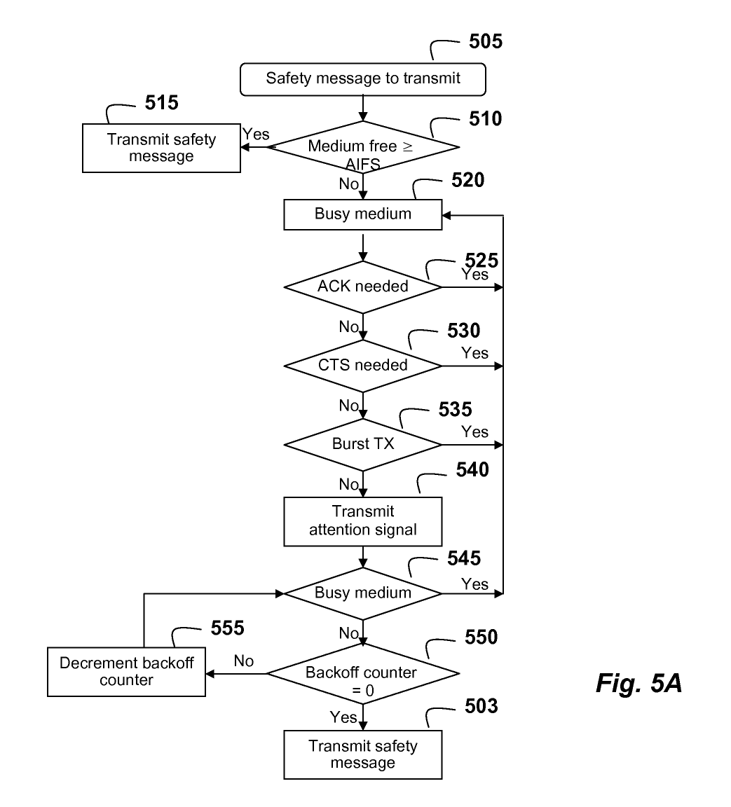

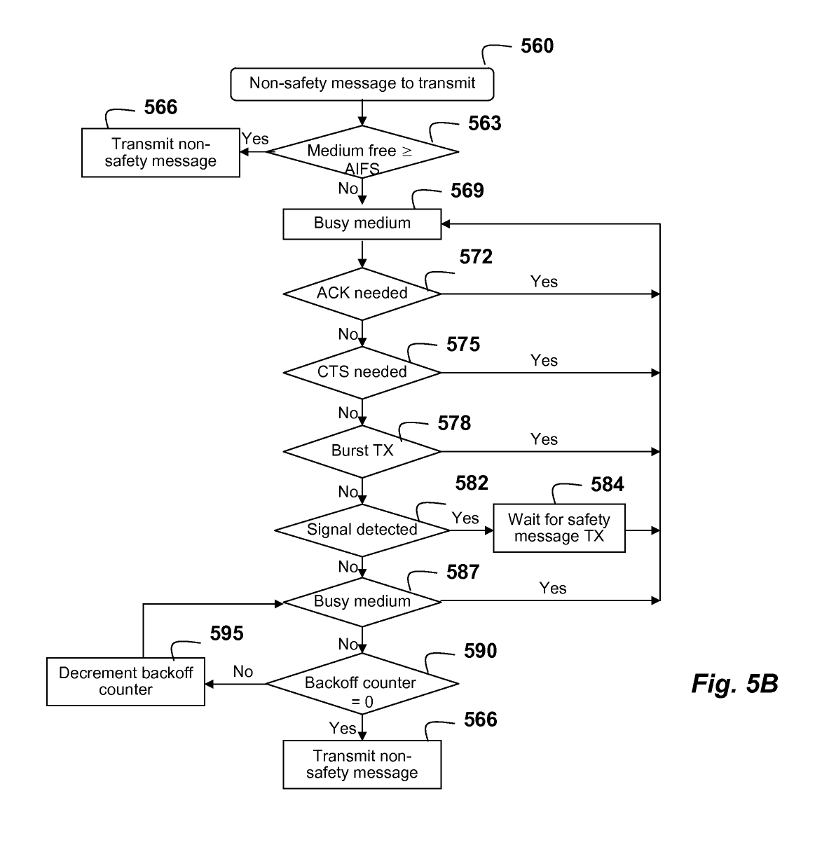

FIGS. 5A-5B show the signaling technique for the safety message node and non-safety message node, respectively. The signaling technique works on all channels specified by the various standards. It fits CCH especially well because CCH is a broadcast channel.

In FIG. 5A, the node has a safety message 505 to transmit. The node checks if the medium is free for more than one AIFS time period 510. If yes, the node transmits safety message immediately 515. If not, the medium is busy 520, the node checks if ACK is needed 525. If not, the node checks if CTS is needed 530. If not, the node check if burst Tx is needed 535. If not, the node transmits 540 the attentions signal. The node rechecks if the medium is busy 545. If not, the node checks whether the backoff counter is zero 550, if not the backoff counter is decremented 555. Otherwise, if yes, the node transmits the safety message 515.

In FIG. 5B, the node has non-safety message 560 to transmit. The node checks if the medium is free for more than one AIFS time period 5630. If yes, the node transmits non-safety message immediately 566. If not, the medium is busy 569. The node checks if ACK is needed 572. If not, the node checks if CTS is needed 575. If not, the node check if burst Tx is needed 578. If not, the node attempts to detect the attention signal 582, and waits 584 for the high priority safety message. Otherwise, the node rechecks if the medium is busy 587. If not, the node checks whether the backoff counter is zero 590, if not the backoff counter is decremented 595. Otherwise, if yes, the node transmits the non-safety message 566.

Adaptive Control Channel Interval Scheme for WAVE Networks

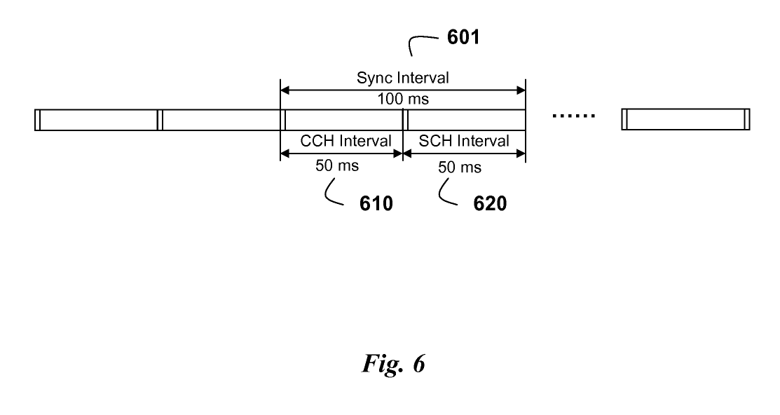

FIG. 6 shows a WAVE partitioning of time into periodic Sync intervals 601. Each Sync interval is 100 milliseconds, and further partitioned into 50 millisecond CCH interval 610 and SCH interval 620, respectively. At the beginning of each channel interval, a 4 milliseconds guard interval accounts for variations in channel interval time and timing inaccuracies. No transmission is allowed during the guard interval. WAVE requires that all nodes monitor the CCH during the CCH interval for control messages, high priority safety messages and the service announcement messages. The nodes can monitor the CCH or the SCH during the SCH interval.

Due to the SCH interval, WAVE imposes a 50 milliseconds latency on high priority safety message dissemination. During SCH interval, nodes are allowed to be on any channel. If an accident occurs at the beginning of SCH interval, it takes at least 50 milliseconds for nodes to receive the accident notification if the notification is held to next CCH interval. The notification transmitted on any channel during SCH interval can only be received by nodes on same channel. Nodes on different channels cannot receive the accident notification.

Adaptive Control Channel Interval

For nodes on different channels, safety messages can be delayed for at least 50 milliseconds. The 50 milliseconds latency does not satisfy the SAE's 10 milliseconds requirement. To reduce the 50 milliseconds latency in WAVE networks, the embodiments of the invention provide an adaptive control channel interval (ACCHI) scheme.

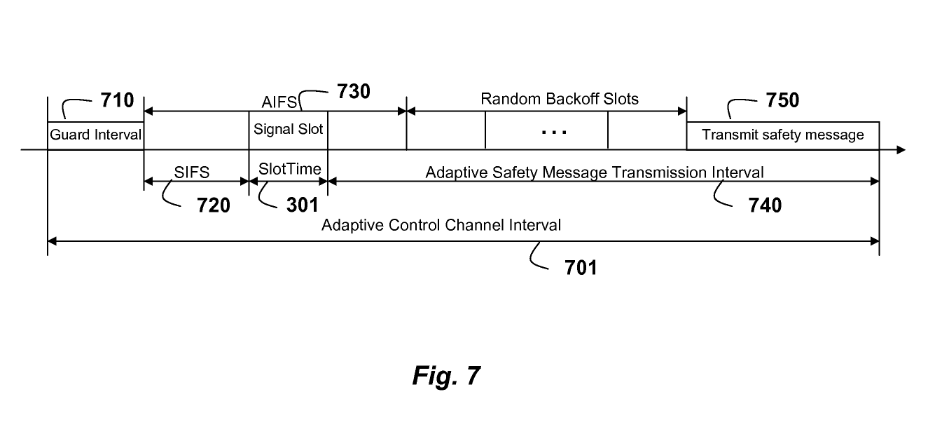

FIG. 7 shows the ACCHI 701, which includes the guard interval 7101, the SIFS slot 720, the attention signal slot 730, and the adaptive safety message transmission interval 740. The length of adaptive safety message transmission interval is variable. The interval is zero when there is no attention signal transmitted. All nodes monitor the CCH at the beginning of the ACCHI.

The node needing to transmit the high priority safety message transmits the attention signal during the signal slot 730 and transmits high priority safety message 750 on the control channel following the EDCA random backoff procedure. The node can resume activities on other channel after the high priority safety message transmission. Nodes without a high priority safety message must monitor for the attention signal in the signal slot 730. If no attention signal is detected, the ACCHI terminates, and all nodes can resume their previous activities. If the attention signal is detected, non-safety message nodes monitor the control channel for up to five time slots following the signal slot to receive the high priority safety message because the maximum backoff time after signal slot on CCH is four time slots, and the high priority safety message transmission can start in the fifth slot. After receiving the high priority safety message, non-safety message nodes can resume their previous activities.

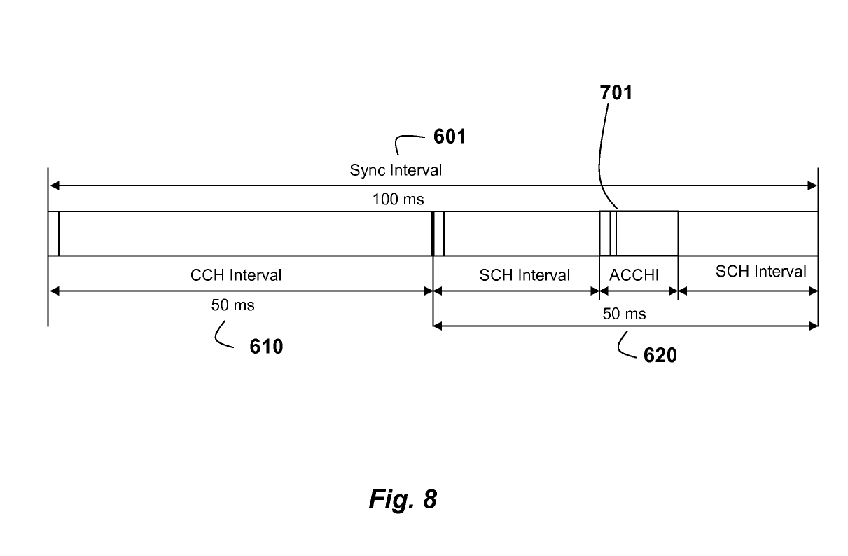

FIG. 8 shows an example of Sync Interval 601 with one ACCHI. 701. It is understood that multiple ACCHIs can included during the SCH Interval 620.

### EFFECT OF THE INVENTION

The embodiments of the invention provide signaling technique for channel congestion control in vehicular ad-hoc networks (VANETs). The signaling technique guarantees that high priority safety messages are transmitted before other messages. The channel congestion control, which operates at the MAC-PHY layers, directly controls channel access.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for broadcasting a message related to a vehicular environment using a network of nodes, wherein each node includes a transceiver and a processor arranged in a vehicle, wherein a bandwidth of the network is partitioned into a set of channels including a control channel (CCH) and multiple service channel (SCH), wherein time is partitioned into alternating control channel intervals (CCHI) and service channel intervals (SCHI), comprising the steps of:
transmitting, by a particular node in a network, an attention signal indicating an intent to access a particular channel to transmit a high priority safety message, wherein the network is designed according to a standard for a vehicular environment;
waiting a random length backoff time; and
transmitting the high priority safety message related to the vehicular environment after the random length backoff time.

2. The method of claim 1, wherein the standard is IEEE 802.11p.

3. The method of claim 1, wherein the standard is IEEE P1609.

4. The method of claim 1, wherein the standard communications access for land mobiles (CALM).

5. The method of claim 1, wherein the channel is the CCH.

6. The method of claim 1, wherein the channel is one of the SCH.

7. The method of claim 1, wherein the backoff time is after a short interframe space time.

8. The method of claim 1, further comprising:
deferring transmissions by other nodes allocated to the particular channel when detecting the attention signal.

9. The method of claim 1, wherein the control channel interval is adaptive and variable in length.
